(19) United States
(12) Patent Application Publication
(10) Pub. No.: US 2007/0168340 A1
(43) Pub. Date: Jul. 19, 2007

(54) Methods and systems for enabling the collaborative management of information using persistent metadata

(75) Inventors: John J. Mahoney, Princeton Junction, NJ (US); Isaak Karaev, New York, NY (US)

Correspondence Address: JLB CONSULTING, INC.;c/o INTELLEVATE, P.O. BOX 52050, MINNEAPOLIS, MN, 55402, US

(73) Assignee: Instant Information Inc.

(21) Appl. No.: 11/184,596

(22) Filed: Jul. 19, 2005

Related U.S. Application Data
(60) Provisional application No. 60/642,685, filed on Jan. 10, 2005.

(51) Int. Cl. G06F 17/30

(52) U.S. Cl. 707/4

(57) ABSTRACT

A centrally managed system (100) is provided which enables the collaborative management by users (108) of information. Through the establishment of metadata schema (300) and the collection and persistent storage of metadata (500, 1900), the system provides users (100) with richly enabled features for managing information and performing collaborative activities. These features include the ability to easily find, recall and share a rich variety of information types with other users (100).

### REFERENCE TO RELATED APPLICATIONS

This application claims the benefit of U.S. patent application Ser. No. 60/642,685 filed Jan. 10, 2005. This application is related to co-pending U.S. patent application Ser. No.______ (attorney docket no. J112U003US00) filed on same date herewith, titled: METHODS AND SYSTEMS FOR ENABLING THE COLLABORATIVE MANAGEMENT OF INFORMATION USING CONTROLLED ACCESS ELECTRONIC WORKSPACE; by Karaev, I. and Mahoney, J. and to co-pending U.S. patent application Ser. No.______ (attorney docket no. J112U004US00) filed on same date herewith, titled: METHODS AND SYSTEMS FOR ENABLING THE COLLABORATIVE MANAGEMENT OF INFORMATION BASED UPON USER INTEREST, by Karaev, I. and Mahoney, J., the entirety of each of which is incorporated herein by reference.

### FIELD OF THE INVENTION

The invention relates generally to information management and more particularly to an information collaboration and exchange system using metadata-based information tagging.

### BACKGROUND OF THE INVENTION

Unlike their physical counterparts, the costs of digital packaging and electronic delivery of all types of information have moved very close to zero. Sending an email simply requires a digital connection between individuals—typically the Internet. Building a web site, publishing a blog, and sending an instant message are likewise virtually zero cost. Sharing of all types of data—files, news, photographs, audio, video and others—has become simple and essentially free.

This decrease in the complexities and costs associated with sharing data has given rise to an exponential increase in the amount of content available in any number of digital formats. Many different types of data are now freely shared over the Internet, for example: text, images, audio, video, multimedia combinations and others as will be known to the reader. Further, all of these different types of data can be packaged, transmitted and read in many different types of formats.

Each data type presents its own challenges with respect to sorting, finding and use by an end-user. For example, until recently, it has been nearly impossible to search audio and video files based on the content of those files. Even where the content of file types such as text are readily determinable and searchable, many different types of formats exist which must be processed and evaluated.

Free e-mail systems such as Yahoo® Mail, Google gmail®, Hotmail® and others known to the reader enable everyone with access to a computer and the Internet to freely partake of electronic mail. File sharing systems such as Grouper®, Napster® and others known to the reader have been developed which enable users to share files. In recent times, blogs have become pervasive, enabling interested parties to easily and quickly post information for sharing with others. Specialized systems have been developed and are available for electronic sharing of specialized datatypes. Many known systems exist, for example, for sharing of: photographs, music, video and other information file types.

In addition to the challenge of searching and finding Internet-based data of interest, significant additional challenges arise once data is actually found and moved to a user's personal computer or workspace. Due to the extraordinarily large size and low costs of storage and data management capabilities available on a typical personal computer or workstation, the average user is able to download and store huge quantities of data and information. Once stored locally, organizing, retrieving and using personal computer-based data provides many of the same challenges as finding data on the Internet.

While on the surface appearing beneficial, the efficiency and pervasiveness of digital data communications, and particularly Internet delivery, has in many cases eroded the value of the content being delivered by it. Without the constraint of real costs, the ability of individuals and other entities to generate and distribute content in all its expressions has far out-stripped any one individual's ability to discover, sort, identify and consume those items that may be useful or interesting to them.

Many different solutions have been developed for enabling users to sort large quantities of data to identify information of interest. Search engines, for example, search and index large quantities of Internet-based web pages, making the information both indexed to and searchable by a user. Google®, Yahoo®, A9® and others are examples of well-known commercially available Internet search engines. Similar search engines, for example Copernic™, X1™, and others have been developed for desktop users. Search engines, however, have many limitations. Much online information remains which is as yet unindexed by Internet search engines. Search engines return information in sorted order dependent on the particular algorithms employed by each engine. It is up to the end-user to search through the results provided by search engines, identifying particular information of relevance and interest. It thus becomes quite difficult and time-consuming to repetitively use search engines to find important business information.

Numerous online, searchable, subscription electronic databases have been developed which provide paid users the ability to search and access specialized types of information. Delphion®, for example, contains highly-specialized patent information available to subscription researchers. Reuters®, Bloomberg® and Thompson® are examples of multi-national information services corporations that provide highly-specialized information to subscription end-users in a variety of financial, legal, scientific and other industries.

The reader will thus appreciate many of the challenges associated with effectively finding, sharing and using electronic data in today's world.

While there have been discussed above the issues associated with finding and managing networked data and local data, yet another user environment exists which shares the challenges associated with both networked and local data. More particularly, “office” types of environments have become increasingly common wherein users obtain the ability to share data with other users, both geographically local and geographically disperse, in a virtual electronic office environment. Electronically-defined offices may comprise, for example, geographically local employees within a single organization, geographically disperse employees within a single organization, employees within multiple organizations linked for the purpose of accomplishing particular tasks, and/or combinations of all of these.

In addition to the above-described tools developed to facilitate individual data and/or communications types, integrated systems have been developed for use in the daily navigation of a typical office-type environment requiring finding, using and sharing multiple electronic data types. WorldStreet Corp., for example, is an example of an early financial services industry communications system. To the best knowledge of the present inventors, WorldStreet Corp. is no longer in operation.

Lotus Notes™ is another example of a collaborative, sharing type environment which enables authorized users to share various combinations of data and software applications, while also enabling user messaging capabilities. Existing collaborative software, however, presents many challenges. Lotus Notes™, for example, requires the installation of extensive local software as well as centrally-managed software. Its functionality is most appropriate for content creation and workflow purposes. Further, this and other tools described herein below provide relatively limited functionality with respect to the ability to find, store, sort and use data.

Groove Virtual Office™ is another example of an information collaboration system enabling participants to collaborate in sharing data and information. To the best knowledge of the present inventors, Groove Virtual Office users to connect locally on a peer to peer basis, but requires a client hosted server based system (requiring central administration and set up) to handle non-local or disconnected users. Groove Virtual Office, while supporting different content types, treats them as anonymous sharable objects and is relatively limited in providing users the ability to easily find, share and use information. For further information, the reader is directed to www.groove.com.

Yet another example of a collaborative information tool is MindAlign on Connex™, a collaborative messaging tool that provides value added capabilities with respect to messaging and communications. To the best knowledge of the present inventors, MindAlign is relatively limited in operation to facilitating communications such as e-mail, instant messaging, audio and other types of person to person communications. It provides no context around the information that is part of the collaboration it supports and thus has limited value for content centric collaboration. For further information relating to MindAlign, the reader is directed to www.parlano.com.

Despite many of the available tools and services, finding useful information in the growing sea of content is a challenge. Many valuable items are simply never found, hidden beneath piles of spam and other marginal content. A great deal of unique and interesting content remains un-indexed, even by large search engines. That which is indexed is usually not categorized in very meaningful ways, and is often crowded out by similarly indexed sources, most of which are irrelevant to the individual searching for content. Even content which is found and subsequently moved to a local computing system often becomes lost and unavailable for future use.

### SUMMARY OF THE INVENTION

The present invention provides collaborative information discovery, sharing, management and use capabilities that overcome many of the challenges and limitations of the prior art.

In accordance with one embodiment of the invention, there are provided methods and systems for sharing electronic information, a method comprising: establishing on a computer a centrally managed electronic information management system; enabling a plurality of users to access the system; establishing at least one user metadata schema stored on the system associated with each of the plurality of users; receiving, in accordance with the user metadata schema, user metadata pertinent to each of the plurality of users and storing the user metadata in association with each of the plurality of users; establishing a plurality of information assets electronically accessible on the system; establishing at least one asset metadata schema stored on the system associated with each of the plurality of information assets; and receiving, in accordance with the asset metadata schema, asset metadata pertinent to each of the plurality of information assets and storing the asset metadata associated with each of the plurality of information assets; whereby the system persistently stores all user metadata and information asset metadata under centralized management.

### DESCRIPTION OF THE DRAWING FIGURES

These and other objects, features and advantages of the present invention will be apparent from a consideration of the following Detailed Description of the Invention when considered with the drawing Figures, in which:

FIG. 1 is a block diagram showing one example of a hardware configuration of a collaboration system in accordance with the present invention;

FIG. 2 illustrates a graphical user interface, or GUI, of a core directory;

FIG. 3 is a block diagram illustrating the directory structure whereby scheme are established for managing metadata in accordance with the present invention;

FIG. 4A illustrates a graphical user interface of a user information entry screen;

FIG. 4B illustrates a graphical user interface of a user general information entry screen;

FIG. 4C illustrates a graphical user interface of a user detailed information entry screen;

FIG. 5 is a flow chart showing a process of establishing a personal user identity with persistent metadata in accordance with the present invention;

FIG. 6 is a graphical illustration of a workspace page within the collaboration system;

FIG. 7 is a graphical illustration of a different view of a workspace page within the collaboration system;

FIG. 8 is a flow chart showing a process whereby a user can request access to another user, and the other user can establish the level of access they wish to enable;

FIG. 9 illustrates a graphical user interface of a directory search web page;

FIG. 10 illustrates a graphical user interface of a subscription access request web page;

FIG. 11 illustrates a graphical user interface of a subscription access granted web page;

FIG. 12 illustrates a graphical user interface of a subscription list web page;

FIG. 13 shows a flow chart of a process for establishing subscriptions;

FIG. 14 shows a graphical user interface for defining a filter;

FIG. 15 shows a graphical user interface for saving a defined filter;

FIG. 16 is a flow chart describing a process for establishing filters;

FIG. 17 illustrates a graphical user interface of a web page for publishing a document;

FIG. 18 illustrates a graphical user interface of a web page for associating metadata with a published document;

FIG. 19 is a flow chart showing a process for publishing a document; and

FIGS. 20, 21 and 22 are diagrams, respectively, of discreet, roll-up and refined routing interest tree structures

### DETAILED DESCRIPTION OF THE INVENTION

The present invention provides a workspace collaboration system which improves upon the way people discover, share, manage, and use information. As will be apparent from a consideration of the detailed description of the invention set out below, amongst other features and advantages, the present invention:
offers a well tagged, permission based directory of individuals, content, applications, services, and other physical and digital assets. People, content and applications/components are all well tagged entities. Tags are defined by a single global schema, and any number of asset and domain specific schemas.
supports metadata persistence regardless of how information is used (e.g.—if a document is sent as an attachment to a message, the tagging associated with the document is carried in the message as well as the document itself and the tags associated with the sender and recipients.)
supports interactions and exchanges between individuals both within a single firm/company and cross-firm/company
supports the tagging of sent messages with recipient advertised tags.
allows individuals to control who has access to them, and to any content or applications they manage or wish to publish.
allows individuals to organize information they discover into a structure that reflects their view of its utility and context
supports the creation of content filters that will automatically route
allows individuals to organize into teams that can discover and share content collectively in ‘workspaces’ —a combination of content, people and application assets organized around the needs of the team and linked contextually.

As used herein, the phrase “for example,” “such as” and variants thereof describing exemplary implementations of the present invention are exemplary in nature and not limiting.

Description of the System

For purposes of facilitating a description of an embodiment of the present invention, and illustrated embodiment of the invention will now be described with respect to the following general functions:
a description of the hardware components and interconnections of a workspace collaboration system,
a description of the core directory structure and persistent metadata function,
a description of a process for establishing a persona with persistent metadata,
a description of a process for granting a workspace end-user access to a workspace,
a description for searching within the collaboration system,
a description for subscribing to data within the collaboration system,
a description of filtering within the collaboration system, and
a description of a publication process within the collaboration system.
   System Description

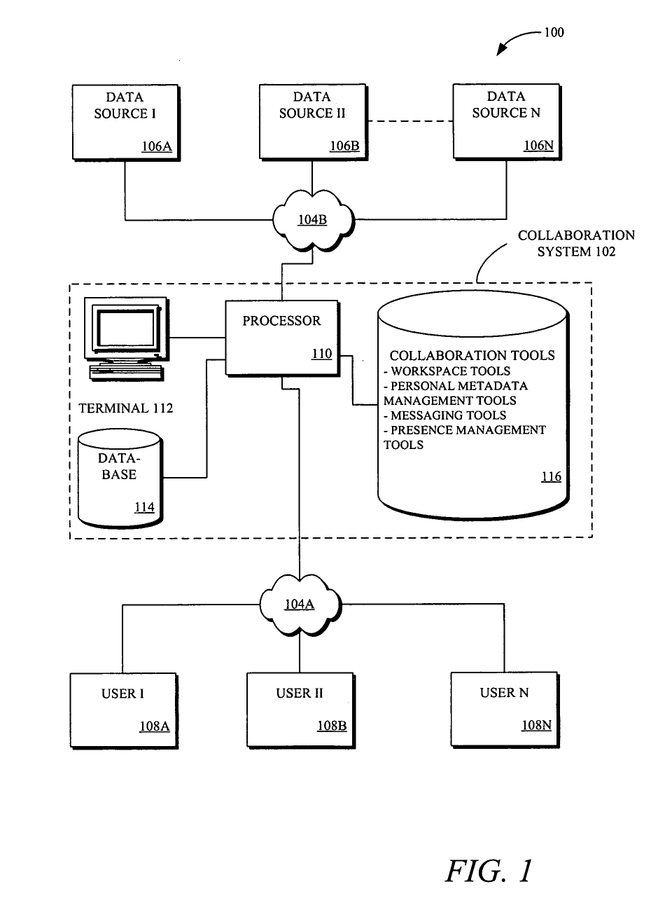

With reference now to FIG. 1, there is shown a system 100 including a workspace collaboration system 102. Workspace collaboration system 102 is connected through appropriate network interfaces 104A, 104B to a series of external data sources, three of which are indicated at 106A, 106B, 106N. Workspace collaboration system 102 is similarly connected to a series of external users, three of which are indicated at 108A, 108B, 108N. Shown in simplified format for purposes of explanation, collaboration system 102 is seen to include a processor 110 connected to a user terminal 112, a database 114, and a set of software collaboration tools indicated at 116.

In the described embodiment of the invention, collaboration system 102 is operated by an application service provider (ASP), a configuration well known to the reader.

Many different configurations will be known for system 102, capable of performing the functions described herein. For example, system 102 may comprise a conventional server or a mainframe computer connected to a network such as the Internet through network connections 104. Similarly, terminal 112 comprises a conventional user interface to system 102. Database 114 comprises an appropriate arrangement of magnetic, semiconductor, optical and other appropriate types of memory. Collaboration tools 102 comprise software tools, for example stored in database 114, configured to perform the functions described herein.

As will be understood by the reader, collaboration system 102 is shown in simplified format for purposes of describing the invention. For example, the system may comprise multiple co-located and/or geographically diverse systems, interconnected in one of many well- known configurations. Similarly, numerous ones of each of the described components may be included in the system.

Continuing with reference to FIG. 1, data sources 106A-N comprise one or more of many external data sources, for example news and information channels. Users 108A-N represent conventional human users operating through appropriate user-interfaces, for example comprising personal computers, portable user devices such as laptop computers and/or personal information devices and other devices capable of communicating over the network 104 with collaboration system 102. As will be described in further detail herein below, users 108A-N are configured to have conventional computing and communication capabilities, such as: e-mail, VOIP telephony, instant messaging, and others as are known to the reader.

In accordance with the illustrated embodiment of the present invention, users 108A-N access collaboration system 102 through the Internet. As noted above, in the described embodiment, collaboration system 102 is operated as a “turn-key” system by an ASP. Navigating in a conventional manner to a web page transmitted through the network by collaboration system 102, a user will download and interact with a series of web pages, or graphical user interfaces (GUI) providing the capabilities, functionalities and processes described herein below.

It will be appreciated that, in accordance with a significant advantage of the present invention, collaboration system 102 is developed and maintained by the ASP remotely from the user's, relieving the users of obligations and responsibilities for developing and maintaining the system, while still providing the users with significant customizable functionality. Further, the below—described methods and systems for collecting, storing and using persistent meta-data are readily handled in a centralized manner. Again, the details of this functionality are described herein below.

Core Directory, Schema and Persistent Metadata Structure

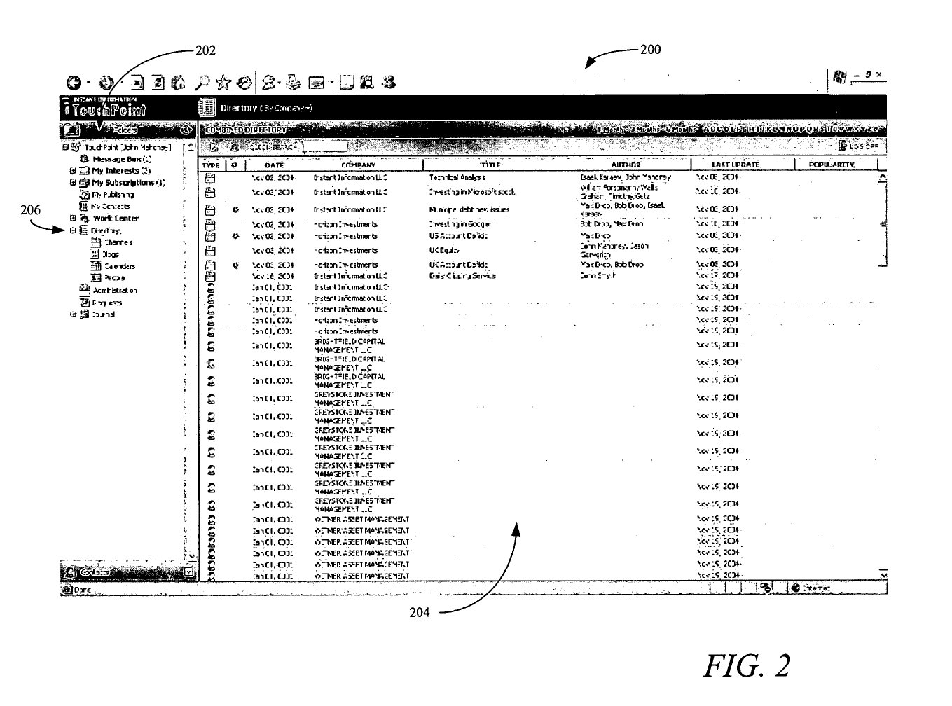

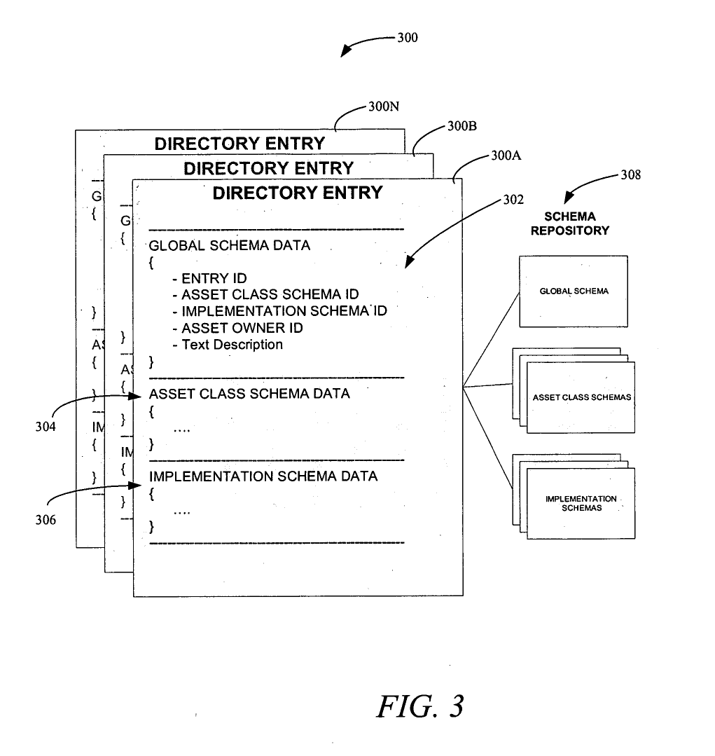

With reference now to FIGS. 2 and 3, there is shown a graphical illustration of a core directory (FIG. 2) and a block diagram illustration of a directory structure including various schema for managing metadata (FIG. 3).

With reference first to FIG. 2, there is shown a graphical display of a virtual work area in the form of a directory web page 200 including, in a conventional Windows™ format, a leftmost portion 202 indicating a list of available folders and a rightmost portion 204 showing a list of contents of a selected folder. Upon access to collaboration system 102, subsequent to any conventional login/security web pages, a user will typically enter into this directory web page 200. In FIG. 2, the directory folder 206 is shown highlighted, whereby the contents of that folder are shown illustrated in section 204. The ‘Directory’, shown in this implementation as a folder, is the place an authenticated user can go to see what asset sources exist in the system that might be available to them, and to request access to specific asset sources from the owners of those sources. As noted earlier every asset and asset source in the system, including users, includes therewith persistent, descriptive metadata. A user is therefore also able to search for asset sources using this metadata, simplifying discovery of assets that may be of value to them. As will be apparent to the reader from a consideration of this description of the invention, such meta-data may be provided by a user, assigned by a system, or developed by both.

Every entry in the directory has at least one owner responsible for the asset it represents. Every directory entry further contains permissions associated with it. These permissions describe:
The visibility of the entry itself to people/entities searching in the directory.
The metadata that is visible to a specific individual that can view the entry. At a minimum, this typically includes the ‘Name Of The Asset’, ‘Owner Of The Asset’, and ‘Organization/Firm Of The Asset Owner’. Each asset contained within the system has associated there with an access/permission level to the asset, described by an entry associated with the asset, and providing permissions relating to accessing of the asset by users. At a minimum, this typically includes ‘right to access’, ‘right to request access’, and ‘no access’. More granular levels of permission are supported as required by specific uses of both the invention and specific assets. Further details of the permissions and the metadata associations are included herein below.

With reference now also to FIG. 3, directory 206 contains detailed information about all of the assets known within the framework, that is all of the assets available through collaboration system 102 to a user. As used herein, the term “asset” and variants thereof is used interchangeably with and representative of information and data available to and usable by a system user. As shown in the FIG. 3, a series of directory entries 300 are shown, indicated at 300A-N. Each entry in the directory has descriptive metadata associated with it compliant with a global schema 302, descriptive metadata 304 assigned to the class of the asset, descriptive metadata 306 associated with a particular implementation and other usage specific schema as required for specific applications of the invention. For purposes of describing the invention, the various levels of schema are shown illustrated as contained in a schema repository 308 associated with each directory entry 300.

The schema defining each asset type contained in a directory provides the details and structure of the metadata necessary for searching on that asset type, including field names, types, and enumerations. When an entry is placed in the directory, it becomes discoverable via searching to anyone permitted visibility to it. Multiple schemas can be associated with a single asset type. Each schema describes the structure of the metadata required to define an aspect of the asset that needs to be described. For a specific instance of an asset, metadata will be associated with it in a format that conforms to the structure laid out

Within the collaborative workspace described herein, there are provided a variety of different constructs with which users may work. As will be seen below, each construct has associated with it particular schema for storing and using metadata.

Asset Metadata Constructs

The Channels Construct:

Channels provide a mechanism for the distribution of richly tagged content. In the described embodiment of the invention, a channel has four levels of metadata. They are based on three identified schemas—two of which are shared system wide and one which is defined specifically for a channel. When an instance of a channel is created, the metadata in the top level schema defines the channel name, channel owner, channel provider, domain schema id, last update, and total updates. This top level schema applies to all channels but is populated for each channel individually. It is inherited by all of the individual content published in a channel. The next level populates the domain schema based on the domain schema id specified in the top level. Fields in the domain schema can be set at the channel level and will be inherited by all of the individual content published in the channel. These top two levels are what will be associated with a channel in its listing in the directory. Other fields in the domain schema can be set per published item in a channel, and represent the third level of metadata. The fourth level of metadata is the channel content schema. The channel content schema is defined by the publisher of content by creating and associating a valid XSD with a channel when it is defined. (XSD is a conventional XML schema definition as is known in the art.) The channel content schema can contain any fields or enumerations that the channel publisher feels appropriate to describe their own content.

The Mediacasts Construct:

Mediacasts provide a mechanism for the distribution of dynamic media such as audio, video, and presentations. In the described embodiment of the invention, there are five levels of metadata associated with an instance of a mediacast. They are based on three identified schemas—two of which are shared system wide and one which is defined specifically for a media stream. The top level of metadata defines the mediacast name, mediacast owner, mediacast provider, domain schema id, last update, and total updates. This schema applies to all inediacasts but is populated for each mediacast individually. The top level metadata is inherited by all of the individual content published in a mediacast, which are called streams. The next level of metadata populates the domain schema based on the domain schema id specified in the top level. Fields in the domain schema can be set at the mediacast level and will be inherited by all of the individual streams published in a mediacast. These top two levels are what will be associated with a mediacast in its listing in a directory.

Other fields in the mediacast domain schema can be set per published per stream, and represent the third level of metadata. The fourth level of metadata associated with mediacast data is the stream content schema. The stream content schema is defined by the publisher of mediacast by associating a valid XSD with a mediacast when it is defined. The stream content schema can contain any fields or enumerations that the mediacast publisher feels appropriate to describe their own content. Fields in the stream content schema can be set at the root level of a stream, but other fields in the stream content schema can be expressed dynamically in a synchronous way as a stream plays back. These dynamic changes comprise the fifth level of metadata. Note that dynamic changes to metadata defined in the stream content schema can cause a single schema element's value to change multiple times during playback of a stream. (e.g.—a schema element ‘Ticker’ may change multiple times as different companies are discussed in a video.) The dynamic changes in this 5th level metadata can be rolled up to be searchable in aggregate with the 4th level metadata.

The Blogs Construct:

Blogs are common Internet construct that have grow in importance for the creation and posting of simply tagged content usually composed in simple fornats. There are two methods that blog based publishing is handled in the invention. The first method lets the invention simply be aware of existing Internet based blogs. For that, blogs are described in the directory as being external. In the described embodiment of the invention, there are three schema levels of metadata associated with an ‘external’ blog. The top level has the blog name, blog owner, blog author, blog root URL, blog RSS url, default refresh frequency, domain schema ID, last update, and total updates. The second level of metadata populates the domain schema based on the domain schema id specified in the top level. Fields in the domain schema can be set at the blog level and will have an inferred association with all of the individual content posted in the blog. These top two levels are what will be associated with a blog (along with the ‘external’ designation) in its listing in the directory. A third level of metadata is associated with each post in a blog and contains the headline of the post, synopsis of the post, URL of the post, time of the post, and text index of the post. An expression of the invention would typically visit the URL specified by the blog RSS URL at the frequency default refresh frequency to update the list of posts and then generate a text index for each new post found and to delete those no longer available.

The second method of publishing blogs lets the inventive system support all aspects of blog creation, authoring, publishing, and update notification. These blogs are described in the directory as being internal. There are three levels of metadata associated with an ‘internal’ blog. The top level has the blog name, blog owner, biog author, blog ID, last update, and total updates. The second level of metadata populates the domain schema based on the domain schema id specified in the top level. Fields in the domain schema can be set at the blog level and will be inherited by all of the individual content posted in the blog. These top two levels are what will be associated with a blog (along with the ‘internal’ designation) in its listing in the directory. The third level of metadata is associated with each post in a blog and contains fields in the domain schema not fixed at the blog level that can be set per post in the blog, the headline of the post, synopsis of the post, ID of the post, time of the post, and text index of the post.

While both methods provide listing in the directory, the internal method provides much richer tagging, if required, and can leverage the security and commercial framework available to all internally managed publications.

The Calendars Construct:

Calendars provide a mechanism for the distribution of date based information. In the described embodiment of the invention, there are three schema levels which describe the metadata associated with a calendar. The top level has the calendar name, calendar owner, calendar provider, calendar ID, domain schema ID, last update, and total updates. The second level of metadata populates the domain schema based on the domain schema id specified in the top level. Fields in the domain schema can be set at the calendar level and will be inherited by all of the individual events posted in that calendar. These top two levels are what will be associated with a calendar in its listing in the directory. The third level of schema describe the metadata associated with each event in a calendar and contains fields in the domain schema not fixed at the calendar level that can be set per event in the calendar, and a set of RIXML (research information exchange markup language, in the conventional sense) compliant field describing the event.

The Page Library Construct:

The Page Library provides a mechanism for workspace pages to be made available for subscription. (The ‘Workspaces’ component is described herein below.) In the described embodiment of the invention, a page library is described using three levels of metadata The top level of metadata defines the Page library name, Page library description, Page library owner, Page library provider, domain schema id, last update, and total updates. The second level of metadata populates the domain schema based on the domain schema id specified in the top level. The top two levels will be maintained in the directory. For the third level of schema, metadata can be assigned to any fields in the domain schema not fixed at the Page library, along with additional metadata for a textual page description, a unique internal Page ID, and an internal Page version.

The Components Library Construct:

The Components Library provides a mechanism for the distribution of application components such as Microsoft's Web Parts or SOAP based Web Services. In the described embodiment of the invention, a components library is described using three levels of metadata, The top level schema defines the metadata assigning the component library name, component library description, component library owner, component library provider, domain schema id, last update, and total updates. The second level of metadata populates the domain schema based on the domain schema id specified in the top level. The top two levels will be maintained in the directory. For describing the third level of metadata, the invention utilizes the WSDL schema(a standard descriptive schema for web components) for the identification of each component in a component library, further including a unique internal component ID, and internal component version.

The Feeds Library Construct:

The Feeds Library provides a mechanism for the discovery of distribution points of dynamic content such as stock price data, news feeds, or inventory information. In the described embodiment of the invention, a Feeds Library is described using three levels of metadata The top level schema describes the metadata defining the feeds library name, feeds library description, feeds library owner, feeds library provider, domain schema id, last update, and total updates. The second level of metadata populates the domain schema based on the domain schema id specified in the top level. The top two levels will be maintained in the directory. For the third level of metadata, any fields in the domain schema not fixed at the feeds library level can be set, along with a unique internal feedID, and internal feed version, feed URL, and the feed specific schema ID (the schema provided by the feed provider to parse a feed).

It will be seen from a consideration of the description of these constructs and the associated schema with metadata, that the structure and persistence of metadata in accordance with the schema for each construct provides many significant advantages as described and associated with the invention.

Persona with Persistent Metadata

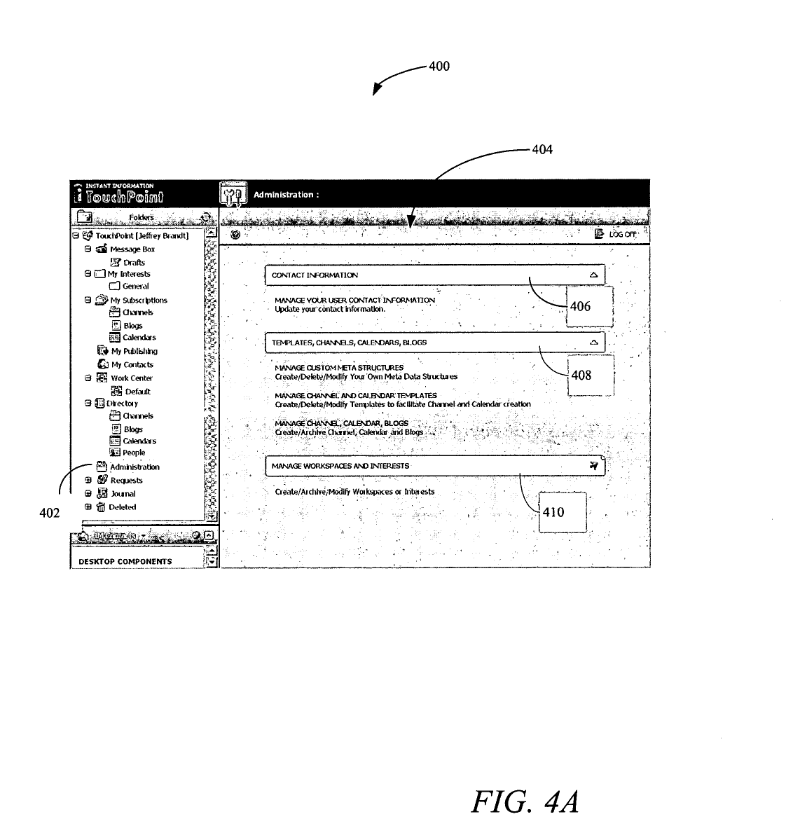

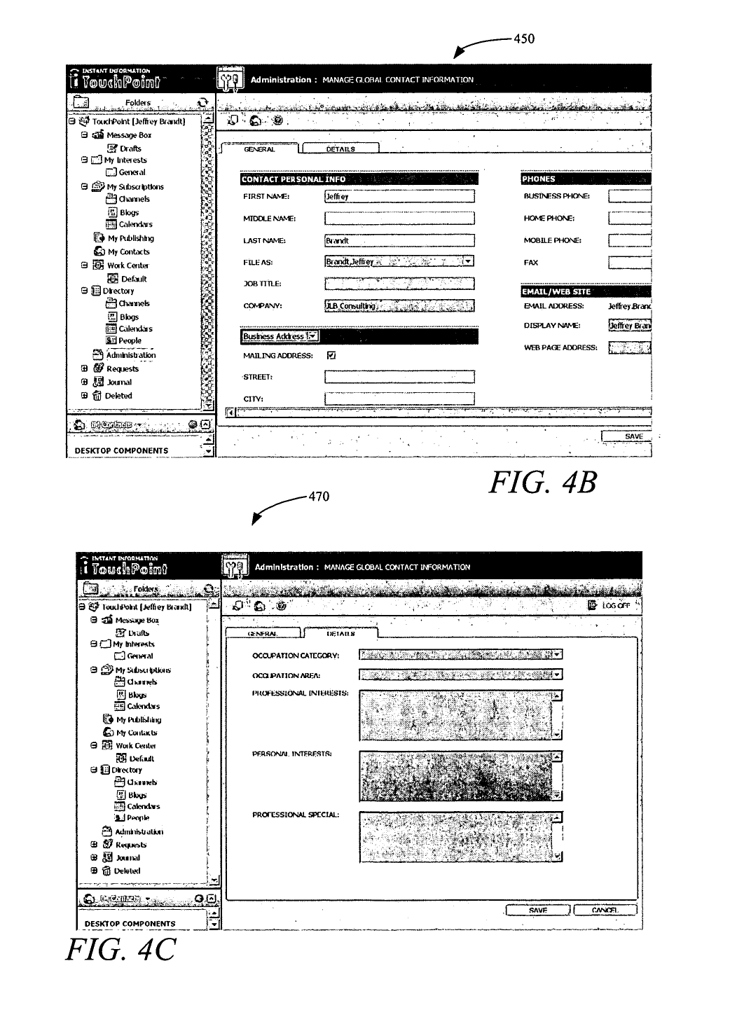

With reference now to FIGS. 4A-C and 5, there is shown and described a process for establishing a persona, or personal user identity, including persistent metadata in accordance with the present invention. FIG. 4A shows an administration GUI 400, wherein an administration folder 402 has been activated by selection to provide a work screen 404 whereby a user may enter contact information 406, templates, channels, calendars & blogs 408 and workspace and interest information 410. FIG. 4B shows a GUI 440 enabling a user to enter general contact, business, telephone and other information. FIG. 4C shows a GUI 470 enabling a user to enter detailed information about selected areas of interest, including but not limited to: their occupation, their professional interests, their personal interests and their professional specialties.

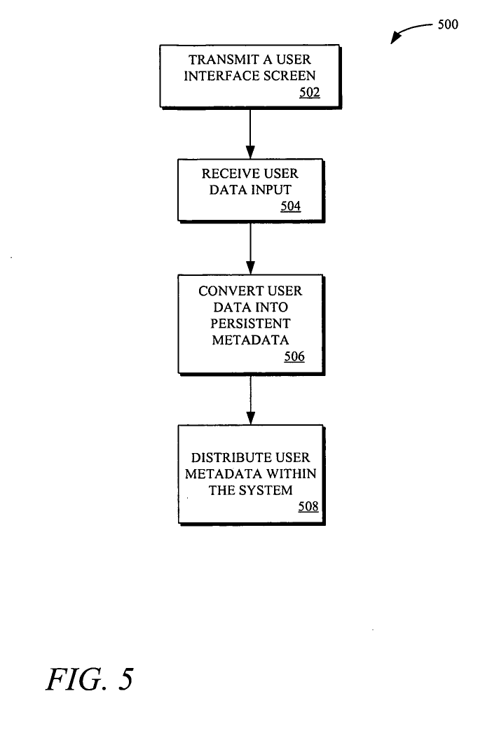

With reference now to FIG. 5, there is shown a process 500 whereby a user creates their own persistent metadata for use within the system. The process includes providing one or more GUI interfaces to the user (step 502), such as those shown in FIGS. 4A-C above, into which the user can enter personal information to be converted into persistent metadata within the system.

The user information is received into the system (step 504) and converted into persistent metadata in accordance with preestablished schema such as those shown and described above (step 506). This persistent metadata, established in accordance with the existing schema, is now available for use within collaborative workspace system 102 (step 508).

In accordance with a key feature of the invention, the above described process enables a user to locally establish relevant information in the form of persistent metadata for use by himself and others in the operation of the collaborative workspace described herein. In establishing their personal metadata, users can identify areas that are of specific interest to them (e.g.—telecommunications), or areas that that have a specific expertise or value in (e.g.—portfolio risk analytics). A user can then share with others this metadata they have associated with themselves, making it easier for others to discover them in the system. Users can also set up their own tags that they want others to use when sending them content or messages.

As will be understood by the reader, this provides the significant advantage of enabling each individual user of the system to establish a persistent persona that becomes an essential part of establishing relationships with others in a collaborative service. It gives users the means of discovering other users with specific needs, interests, or expertise, reducing the difficulty of forming a meaningful context for interaction. As an example, a user that has written a report on mergers in the telecommunications industry could look for individuals they have access to with an interest in telecommunications (based on areas of interest they advertise). Finding one, they see that they would like content sent to them tagged with one of six different tags. Picking the most relevant one ‘RBOC Consolidations’, the first user tags his telecommunications report and sends it to the other. The user that receives the report has it already a metadata schema for tagging incoming assets such as the report in a way that they think about their universe of information; that is in a way useful to them. The sender of the report benefits since it they were able to send it only to someone with a specific interest in it and in a way that it is more visible then an unmarked attachment to an email. The receiver benefits since a potentially relevant piece of content is presented to them in a way that makes it visible and organized in the way they would think about it.

Workspace Development & Management

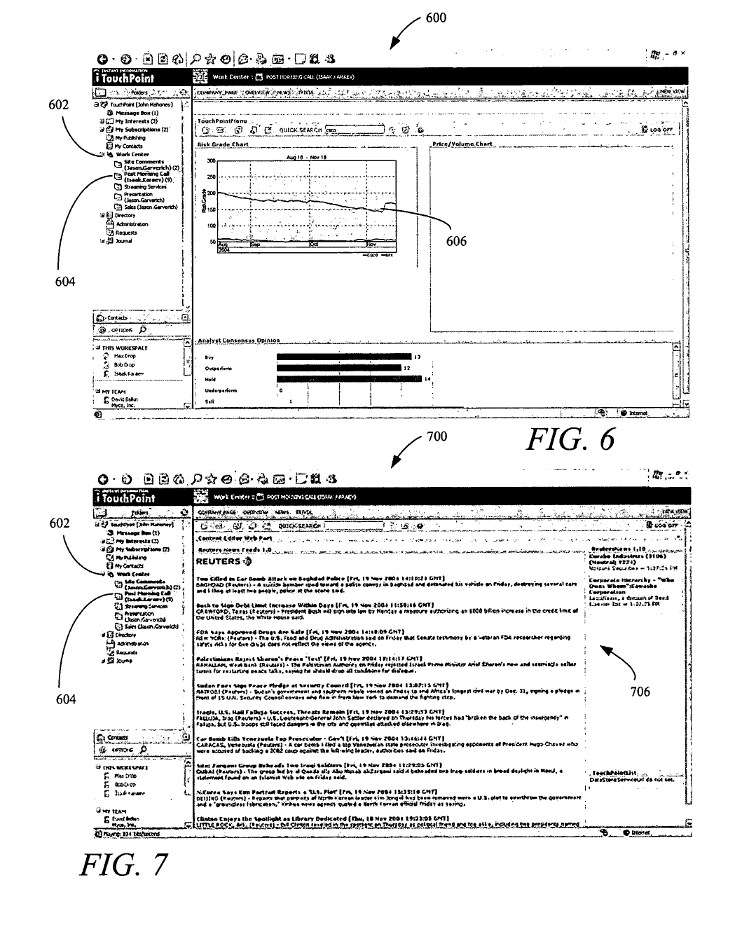

With reference now to FIGS. 6, 7 and the 8, the invention will be seen to provide a mechanism, described herein as workspace, whereby individuals can self aggregate into groups for sharing information with everyone in the group. The individuals that belong to a workspace are called workspace members.

A workspace is a named collection of named pages. Each page is made up of configurable information, presentation, application, and communication components. Pages are formed in accordance with the page constructs described herein above. FIGS. 6 and 7 show examples of different types of pages available within the system.

There are three types of workspace pages available in accordance with the invention. A first type of workspace a private page. A private page is a place that an individual using a workspace can place content that is not meant to be shared with other workspace members. There can be multiple private pages, and they can be constructed of any components that that individual has rights to use. Private pages allow the use of components (e.g. Messaging) that exchange content with individuals that are not workspace members. Content can be sent from a private page to a common page if it is found to be of value broadly.

A second type of workspace page available within the system is a common page. Common pages are visible to all members of a workspace. They can be made up of any configurable components an individual has rights to, but content/messages/information found on a common page cannot be shared with anyone that is not a workspace member, that is, enabled with permission to view the workspace.

A third type of workspace page available within the system is a subscription page. Workplace subscription pages can include pages that are provided by a source that is not a member of that particular workspace, but that provides a service for them. Individual workspace members must have the right to a subscription page, or it will not appear in their workspace. However, unless specifically precluded by the page provider, content can be sent from a subscription page to a common page.

Any individual, that is a registered user of collaboration system 102, can create a workspace (or multiple workspaces). They, the users who create the workspaces, are called the workspace owner. Once created, the workspace owner can invite other people, that is other registered users of collaboration system 102, to share that workspace with them. Anyone that accepts the invitation to join a workspace will find, upon logging on to collaboration system 102, that workspace visible to them. By default, every workspace has a single private page. Each individual has the right to configure that private page that is associated with his user rights to collaboration system 102, and to add additional private pages.

Only the workspace owner can invite people to join a workspace. They, the workspace owners, can also remove existing members from a workspace, and workspace members can also remove themselves. When the owner of a workspace invites other members and they join, every existing member provided with access to that workspace is informed of the new member. The workspace owner can give invited members specific rights within the workspace. For example, certain members may have ‘read only’ privileges. Others may have the rights to add new common pages to a workspace.

The preservation and sharing of context is an important part of the workspace model as described by this invention. No formal contextual schema is set down for use in workspaces. A workspace can use either a domain specific schema, a public schema, or a custom schema to describe context.

Context is metadata data that can be set or accessed by components of a workspace to allow them to share information with other components of a workspace. This shared information allows components to behave in a coordinated fashion, or in ways that are intuitive to a user of the invention. To make context work effectively, it must include a way to limit what parts of a workspace can share a particular contextual element. The application of a limit on context elements is call scope. There are three levels of scope in the workspace context model. Scope can be contained to the components on a single page, across all pages in a workspace, or across multiple workspaces. While scope will typically apply to a single individual using an expression of the invention, that does not always need to be the case. Scope can be extended to apply to a group of users as well, allowing the actions of one user to influence the behavior other users of the system experience.

Page level context allows the individual components that make up a page to interact in ways that enhance their value. A ‘COMPANY’ may be specified in the page context, and every component on that page that uses the ‘COMPANY’ context will update their component to show a relevant display related to that company.

Workspace level context allows each page in a workspace to share contextual elements. If a ‘COMPANY’ was specified in a workspace context, each page in that context would focus their components onto a view relevant to that shared ‘COMPANY’

Context can also be shared across a list of workspaces, affecting each one in a way identical to the above descriptions. One workspace might be set up to analyze information in a certain way, and another may be set up to allow someone to modify it. They could both be driven off the same predicate contextual elements.

If any of these examples were shared across workspace members, every member that visited a specific page in a workspace, any page in a specific workspace, or any contextually linked workspaces, would see the same information about the ‘COMPANY’ specified.

With reference now to FIG. 6, there is shown a workspace page 600 displaying a graph and other graphical content 606 within the workspace display area. The particular content of this page is displayed by selecting a particular web icon 604 within the work center folder 602.

With reference now to FIG. 7, there is shown a workspace page page 700 including a display area with content component 706, the contents selected for display by the user as a result of selecting the same page 604 within the same work folder 606. Though not shown, there can be more then a single component on a page, and components can be of many different kinds; as examples: content, services, media, communications or applications.

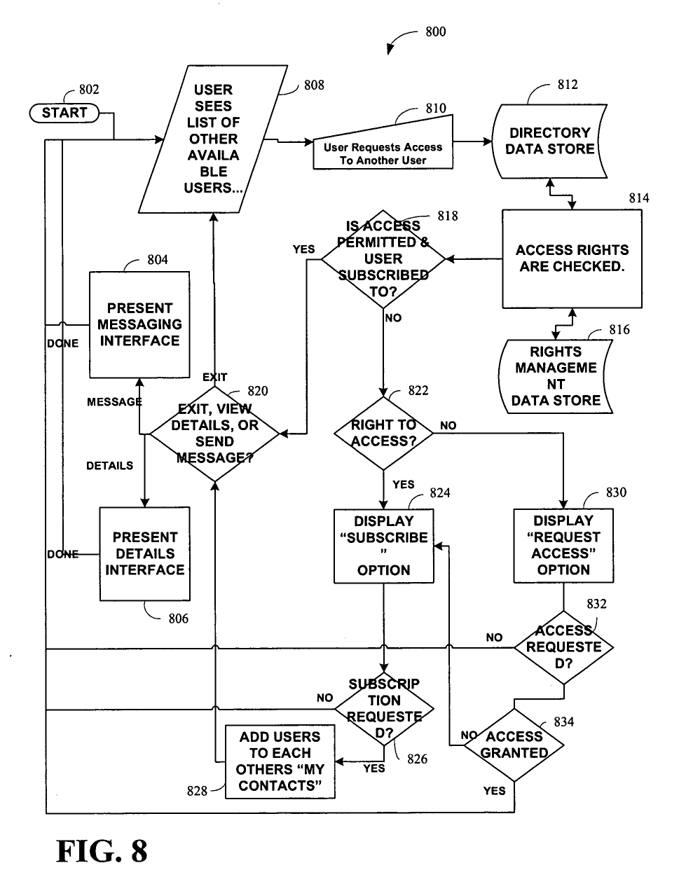

With reference now to FIG. 8, there is shown a process 800 whereby a user is granted access to a process, workspace, data or information of another user. At the start (802) of the process, the requesting user is logged on to collaboration system 102 so as to have access to publicly available system content, including access to his messaging interface 804 and his details interface 806. The requesting user sees a list of other available users (step 808) and requests access to another user (step 810).

Within collaboration system 102, and particularly within processor 110, database 114 and collaboration tools 116, the user request is evaluated within a directory data store (812) to determine what access rights are available (step 814) with respect to rights stored within the data store (816).

If the requesting user is subscribed to and has permission to access the desired user (step 818), then the process terminates with the requesting user being granted access to the appropriate materials (step 820) correct. If the requesting user is not subscribed and/or has not been granted permission to the desired user (step 818) then it is determined if the requesting user has a right to request access to the data (step 822). This right of access is determined by the commercial, personal, or structural relationship these users have with each other, or with a governing third party entity.

If the requesting user has a right of access (see step 822), a subscription option is displayed (step 824), and the requesting user is permitted to submit a subscription request (step 826). If the requesting user chooses not to submit a subscription request, then the process terminates. If the requesting user chooses to submit a subscription request (step 826), then the requesting user is added to the other user's contacts, while the other user is added to the requesting user's contacts (step 828) and the requesting user granted access to the requested materials (step 820).

If, at the time that access is requested, it is determined that the requesting user does not have the right to access the desired material (step 822), then the requesting user's request for access is displayed to the owning user (step 830). If the requesting user declines to request access to the data (step 832), then the process ends. If the requesting user continues to request access (step 834), then the process resumes with step 824 wherein the requesting user is granted the option to subscribe to the desired data. The process then continues as described herein above.

Directory Search

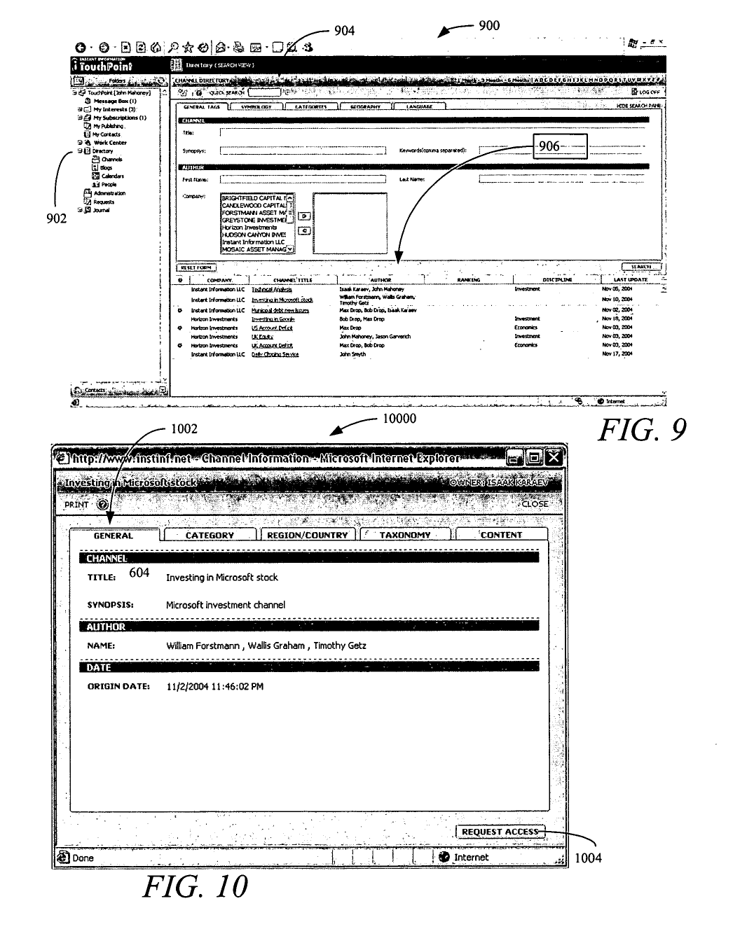

With reference now to FIG. 9, there is shown a GUI 900 enabling a user to search through various forms of available data and information to find and subscribe to information that they would like to view within their workspace. As described herein, many sources of data are available for users of collaboration system 102. The sources are generally grouped within a directory folder 902, and are shown to include: channels, blogs, calendars, and people. As illustrated in FIG. 9, the selection of an information source within directory folder 902, enables a search functionality, indicated within display 904. This search functionality enables a user to search on keywords to identify particular information sources for review and/or subscription.

For example, a user may search within a list of available channels, blogs, calendars and/or people, using keywords to identify information of interest. The system further includes sort capabilities, indicated generally at 906, enabling the user to sort the results of information sources developed as a result of a search. In accordance with the present invention, search terms are applied not only against the content of the various information sources, but also against the persistent metadata associated with each of the sources as developed and stored in accordance with the particular schema described herein above. The more focused a search is in terms of content type, the more detailed this discovery level searching can be. Searching across channels to find one of interest will offer the searcher more options to refine their interest then a general search across all subscribe-able assets. A search for a person can likewise have more detailed focus then a general asset search.

It is thus appreciated that collaboration system 102 provides a user the opportunity to search available information sources whereby to identify the sources of interest for short-term and/or long-term viewing.

Subscription Request Access and Management

When an individual user discovers an asset in a directory that they wish to have access to, they can request access from the owner of the asset. If the individual has been assigned a ‘right to access’ prior to this request, they will have the right to ‘subscribe’ to the asset, and access will be granted to them immediately. If the individual has been assigned a ‘right to request access’, a request, including details about the requesting individual, will be sent to the owner of the asset. The owner can choose to grant or deny access, and define a term. The requesting individual will receive a message informing them of the result of their request. If access was granted, they can then subscribe to it and receive immediate access at that point for the term defined (if any). If the request was rejected, they will be precluded from asking for access to the asset again for the term defined (if any). The details of this process are described herein below. There are specific commercial capabilities defined in the subscription model.

Since access to information assets may require specific agreements between individuals or entities, the subscription mechanism will permit the definition of ‘click based’ contracts that will allow for a term sheet and an Accept/Reject. The results of this agreement will be recorded and archived for both parties.

Since access to assets may require specific commercial considerations between individuals or entities, a commerce capability is defined that will allow direct billing prior to allowing subscription to the asset. A term can also be defined for any commercial transaction.

Access to any asset can be commercialized. This includes individuals and applications as well as the more traditionally considered content.

When an individual subscribes to an asset, it is added to a list containing all of the subscriptions possessed by that individual. Individuals that someone has access to are added to a ‘My Contacts’ directory with whatever details about that person they are granted visibility to.

Any updates or changes to a subscribed asset or to the metadata describing it are immediately made available to the subscriber. As one example, any changes that an individual makes to their directory entry will immediately be available to anyone that has subscribed to it, and appear directly in their ‘My Contacts’ directory. As another example, when new content becomes available from a content source, anyone subscribed to that content source will receive the new content. Subscription rights can be revoked by the owner of an asset.

With reference now to FIG. 10, there is shown a GUI of a web page 1000 through which a user may request access to a directory information source found/located as a result of the above-described search. The page may be displayed by simply selecting a result of a search from a list displayed on web page 1000 above. As shown on the page, there is provided general information 1002 about the information source as well as additional options to display additional information, for example, information source category, geographic location, taxonomy and content. In the lower right hand corner of the page there is provided a graphical button 1004 whereby a user may request access to the information source.

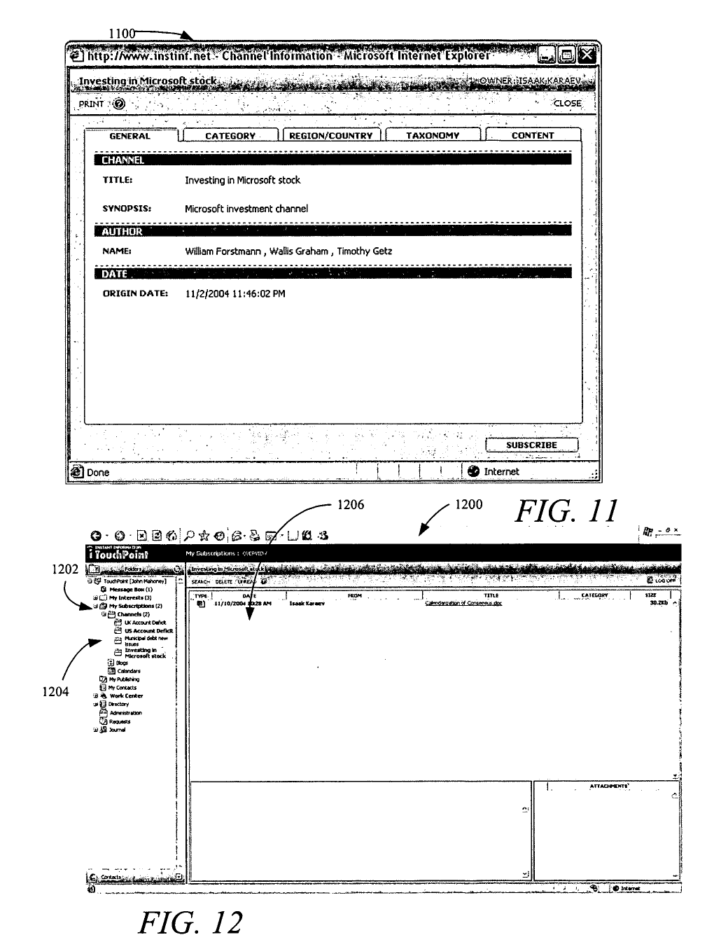

With reference to FIG. 11, there is shown a GUI illustrating a web page 1100, whereby a user may request a subscription to an accessed information source. For purposes of illustration, it is seen that the information source is substantially the same as that to which access was requested using GUI 1000 described with respect to FIG. 10 above. Because the user has been granted access to the information source, the electronic graphical button in the lower right hand corner has been changed to a subscription request button 1102 enabling a user to request a subscription to the displayed information source. Upon selecting the electronic button 1102, the user will be subscribed to the information source in accordance with the process described herein below.

With reference now to FIG. 12, there is shown in a GUI web page 1200 illustrating a list 1202 of information sources to which the user has been granted subscription access. It will be seen that the list is contained within the “My Subscriptions” folder 1204, and may be displayed by selecting the folder. Selecting of any of the subscription sources within list 1202 displays the selected item in a viewable area 1206 of screen 1200. The user may click on the displayed item in order to actually access the item and receive the information contained in the subscribed information source.

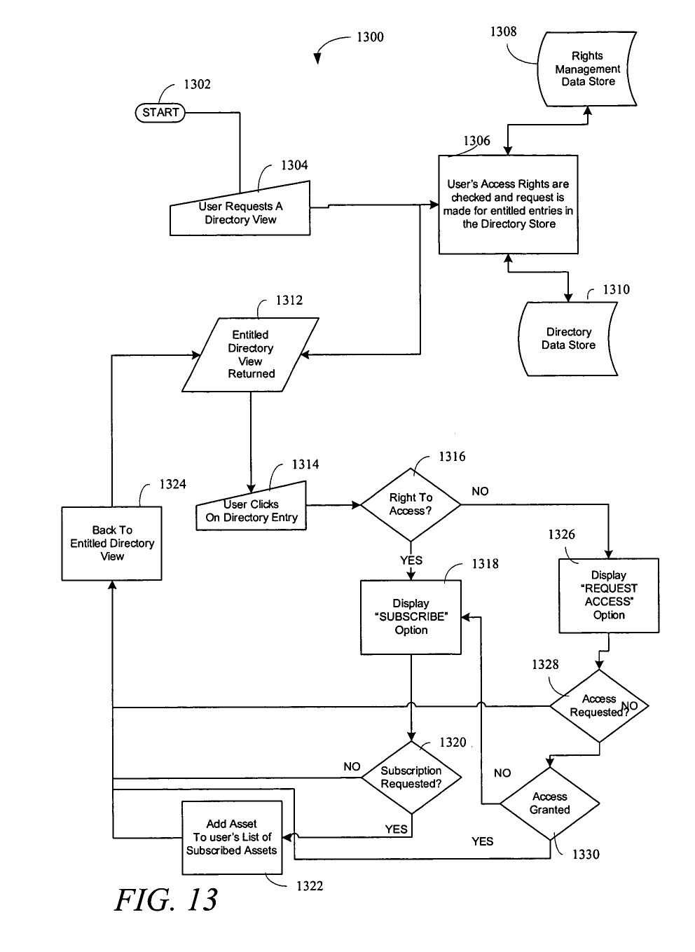

With reference now to FIG. 13, there is shown a process 1300 whereby a user may request and obtain a subscription to an information source using the graphical user interfaces described above. On the initiation of the process (step 1302) a user requests to view a directory (step 1304). The user's existing access rights are checked (step 1306) within both the rights management data storage (1308) and within the directory data store itself (1310).

Simultaneously, a directory view is returned to the requesting user (step 1312). The user will select the returned directory (step 1314) and if he has a right to access that directory (step 1316), then the subscribe option shown in FIG. 11 will be displayed (step 1318). If a subscription is requested by the user (step 1320), then the information source will be added as an asset to the user's list of subscribed assets (step 1322). If the user does not request a subscription (step 1320), he is simply returned to the directory view (step 1324).

If, when the user requests access to the selected information source, he does not have a right to access that source (step 1316), then he is given the option to request access (step 1326). If he chooses to request access (step 1328) and the access is granted (step 1330), then he is given the option to subscribe to that information source (step 1318) and the process continues as described above.

If the user does not request access to the information source (step 1328) or the access is not granted (step 1330), then he is returned back to the directory view (step 1324) as described above.

Establishing and Managing Interest Folders, Filters & Alerts

The invention provides mechanisms for a wide variety of content sets, with associated rich metadata, to be published and exchanged. While it is possible for an individual to visit each ‘subscription’ that is available to them to discover messages, documents, data sets, etc. that might be useful to them, the need to do that repeatedly would greatly diminish the value of the available information. Therefore, three constructs are provided by the invention to give individuals a way to better manage their subscription content—Interest Folders, Filtering and Alerts.

With respect to interest folders, an individual can set up one or multiple trees of folders (Folders nested in Folders, etc.), and name each folder individually. Each tree would reflect that individual's own view of how a specific discipline of content should be organized—their own taxonomy. These are called ‘Interest Folders.’

The invention supports three classes of tree structures for interest folders. It will be understood by the reader that in each class of folder, the metadata established with the content remains with that content regardless of the placement in the folders.

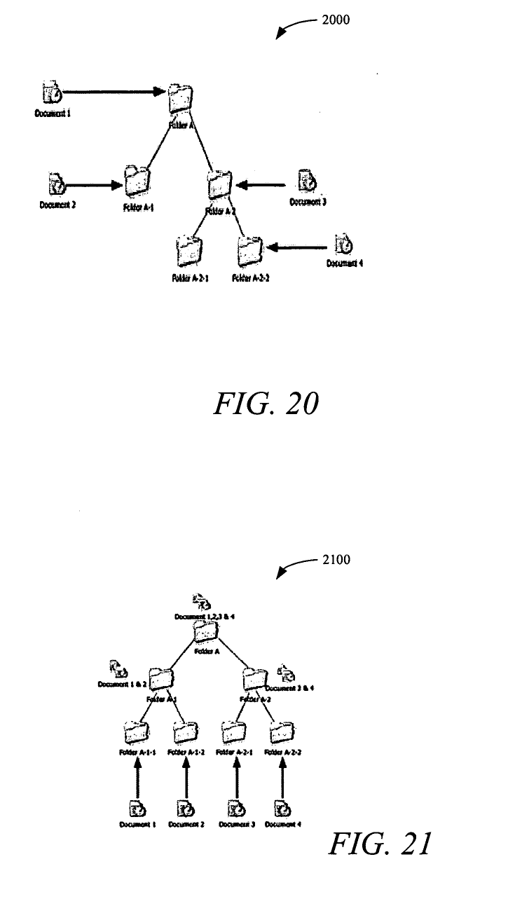

The first class is a simple and discrete folder tree, an example of which is illustrated diagrammatically at 2000 in FIG. 20. Content can be placed into any folder in the tree and simply remains there. This works well where the folder relationships are not specifically related to content being placed in them.

The second class of tree structure is a ‘roll-up’ interest folder tree, an example of which is illustrated diagrammatically at 2100 in FIG. 21. In this tree class, content can only be placed into end point/leave folders, the folders indicated at A-1-1, A-1-2, A-2-1 and A-2-2, and is rolled up into folders above it. This works well where the folder relationship recognizes increasing levels of specificity. For example, there can be end point folders CARS, TRUCKS, and PLANES. They would be under a folder called VEHICLES. Content could only be placed into one of the end point folders, but any content placed into an end point folder would automatically appear in the folder above it. Thus, if an individual went to the folder VEHICLES (which had no content placed into it directly), they would see all of the content placed into the folders CARS, TRUCKS, and PLANES combined. This construct can be as deep as required.

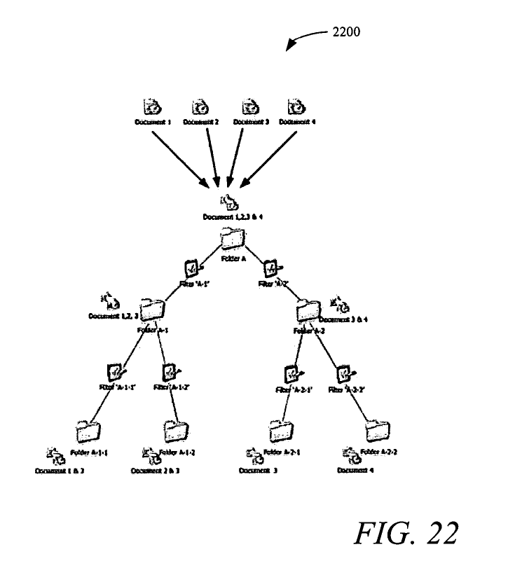

The third class of tree structure is a ‘refined routing’ interest folder tree, an example of which is illustrated diagrammatically at 2200 in FIG. 22. In this tree class, content can only be placed into the root of the tree. Each folder below will then inspect all the content placed into the folder above and determine—based on matches with the metadata or elements of the content itself—it will copy relevant content into its folder as well. The routing rules ‘live in’, that is are associated with, each individual folder, and there can be multiple complex rules in each. If content is copied into this folder, all the folders below this will similarly inspect it, and so on down to the end points of the tree. This type of refined routing interest tree folder is best suited where content needs to be refined, but the same content element may need to belong to multiple folders further down the tree. It will be understood by the reader that this last model could also be expressed as a map of non-hierarchical folder relationships instead of a tree.

The invention supports the ability for an individual to visit every subscription they have and to add any content element they find there directly to any interest folder tree they have set up. However, to make the subscription mechanism more efficient, each subscription provides a mechanism for filtered routing to any interest folder tree. Filters can be set up to identify content in a subscription based on any metadata associated with it, and then route it to any permitted folder in any interest folder tree, or to multiple interest folder trees. Based on the nature and definition of the interest folder tree it is routed to, it may appear in different numbers of relevant, specific folders in each tree.

Interest folders and filtering combine to provide a very efficient mechanism for content from multiple providers and having multiple, subscription specific metadata associations, to be accessible via simple named folder tree navigation instead of the more tedious subscription by subscription search process required by prior art systems.

The invention provides a mechanism to notify an individual whenever content is added to and interest folder tree, or to a specific folder in an interest folder tree. While the invention does not constrain notification to a specific methodology, the likely common methods will be via email, instant messaging, on-screen pop-ups and/or pager/phone/PDA.

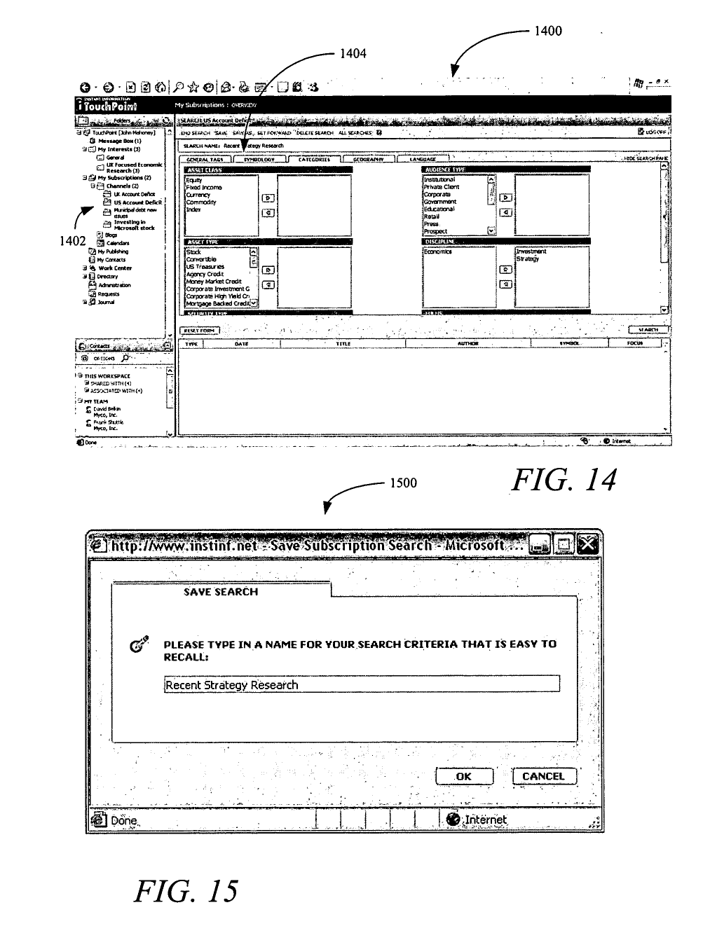

With reference now to FIG. 14, there is shown a GUI 1400 for defining a filter. As shown in the GUI, a particular channel is selected 1402, and a variety of filter terms are provided for selection and entry into a filter list 1404. With reference to FIG. 15, the filter assembled with respect to web page 1404 can be named and saved as a shown in GUI web page 1500.

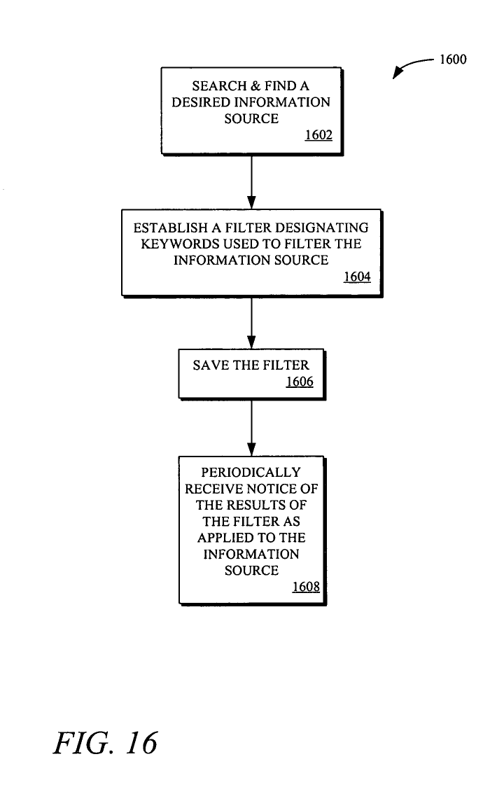

With reference now to FIG. 16, there is shown a process 1600 for establishing and using a filter to filter an information source. In accordance with the process, a search is performed to identify at least one information source of interest in the manner described herein above (step 1602). Upon finding and information source of interest, a filter is established, the filter including keywords for performing automated filtering searches on the information source (step 1604).

The newly established filter is saved (step 1606), and collaboration system 102 periodically applies the filter to the information source. The user can then periodically receive notice of any information resulting from the application of the user-developed filter to the information source (step 1608).

It will be appreciated by the reader that content found by filtering can be deposited in the above-described interest folders. When a filter is established on a content source, it will also permit a target folder to be associated with it that will become the destination for any content found to match the filtering criteria. Once placed in a folder, it will populate through the folder's tree based on the class of the tree structure as described above.

The Publication Process

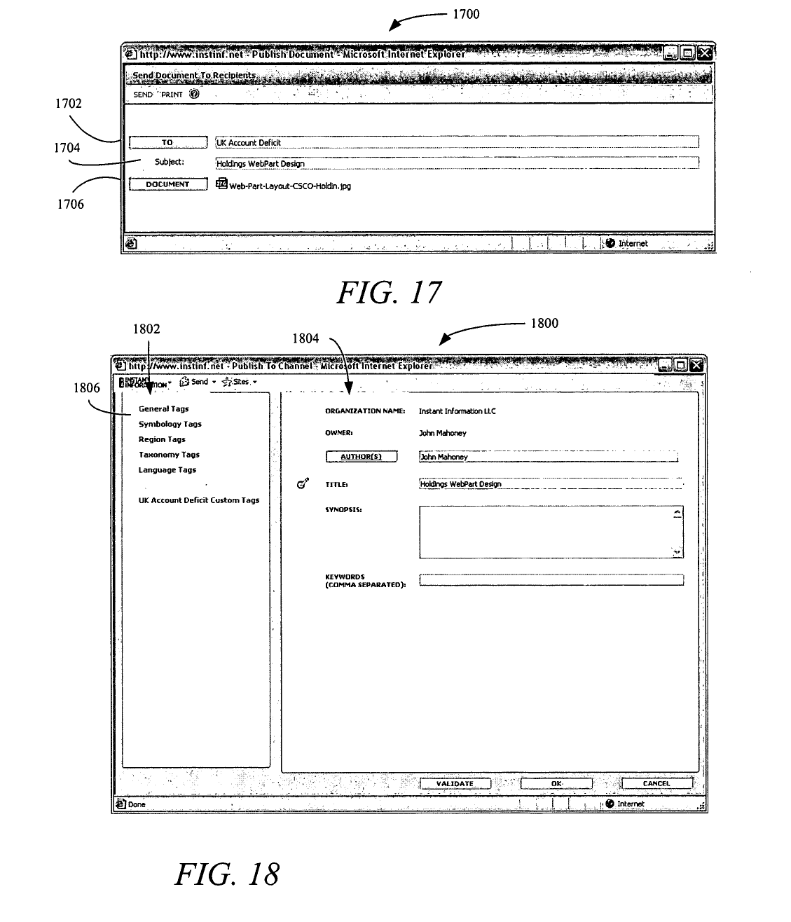

With reference now to FIG. 17, there is shown a GUI 1700 for publishing a document within collaboration system 102 to subscribed users. In contrast to assets that are found through searching, filtering, or otherwise as described herein above, publication is a positive step taken by a content owner to share content with other users. Distinct from messaging which is targeted at a specific individual or group, publishing is targeted at a channel—a permission based access point where people, if allowed, can access the content being published—and provides mechanisms for the attachment of rich meta-data structures to the content items being published.

As is seen in the FIG. 17, web page 1700 includes a user input field 1702 for identifying the recipients, a user input field 1704 for identifying the subject of the publication and an electronic button 1706 for identifying and linking the actual publication. With reference now to FIG. 18, there is shown a GUI 1800, for associating metadata with a publication. As will be seen, a section 1802 of the interface allows the user to identify particular types of metadata, the illustrated types including: general tags, symbology tags, region tags, taxonomy tags and language tags. Associated with each of the tag types is a detailed input screen 1804 including entries for each of the selected metadata types.

In the illustrated embodiment, the general tags metadata input 1806 is selected, and data entry screen 1804 includes fields for general data entry, including: the organization name of the publisher, the owner name of the publisher, the author of the publication, the title of the publication, a synopsis and metadata keywords. It will be appreciated that appropriate metadata entry fields are provided for each of the other tags. It will further be appreciated that many different types of tags and associated metadata may be associated with each publication.

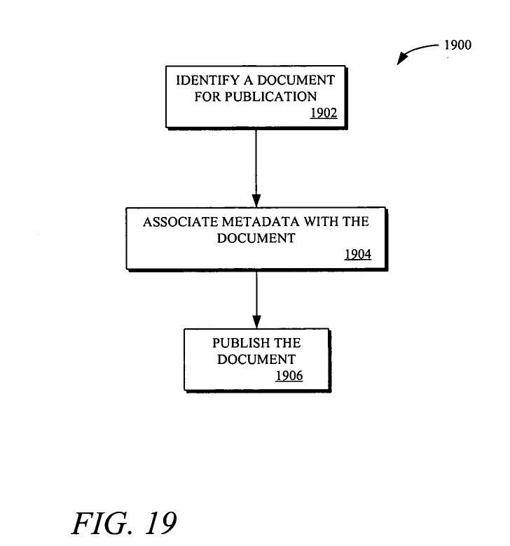

With reference now to FIG. 19, there is shown a process 1900 for publishing a document. In accordance with the process, the document is first identified (step 1902), and metadata is associated with the document (step 1904) using the screens described above (FIGS. 17 & 18), associating and structuring the metadata in accordance with the processes described herein above. The document is then published (step 1906) to make it available to users of collaboration system 102 in a manner described herein above.

There has thus been provided a new and improved workspace collaboration system. The system comprises an ASP solution while providing each user significant flexibility in customizing it to their own use. The system further provides for the inclusion of a rich and persistent metadata with substantially every system asset. Various search, subscription, filtering and interest functionalities make use of the persistent metadata so as to make information assets easy to find and use. The invention has application in the field of information technology, and particularly in the field of collaborative workspace management. In comparison to the prior art:
The present invention provides a directory and permission framework that can operate cross enterprise, allowing individuals at different firms to work together and exchange content.
While being developed and maintained by a remote ASP, the invention is ‘edge configurable’. Beyond defining new users and their commercial rights, every other dimension of the invention can be configured by individual users and requires no central authority. Authorized users can self publish, self aggregate, self subscribe, self describe, and self permission.
The invention preserves deep and rich metadata across all uses of content. It is also associative. A message that is sent with a document attached to it has its own metadata, the attached document's metadata, and metadata about the sender and recipients all associated with it. This enables deeper use of content then is possible with other collaboration systems. (e.g.—A person could find any messages they sent to people in Chicago in the last two months that had documents attached that were about the CBOT. A person could open a message with a document attached about Microsoft, and have a link automatically appear to their internal expert on Microsoft.)
The invention maintains a centralized descriptive directory of all assets know to the system. Assets include people, content, application components, and data sets.
The invention provides a framework where individuals can permission access to themselves, and define their availability using an enhanced presence model.
The invention allows individuals to advertise what classifications they would like to have associated with message others send to them. This places the first level filtering burden off of the message recipient and on to the message sender where it more appropriately belongs.
The invention provides a framework for the commercialization of person to person interactions and access. An authorized user could add a commercial intermediary to charge another individual for the to access them via IM, telephony, or messaging
The invention provides a method for users/publishers to define their own descriptive schemas at the content level, while maintaining visibility in an aggregated space via high level common and domain specific tags.
The invention provides a method for using detailed publisher defined schemas for discovering content via searching and filtering, and combines it with tools for organizing this discovered content into local taxonomies express within user defines folder structures.

While the invention has been shown and described with respect to particular embodiments, it is not thus limited. Numerous modifications, changes and improvements within the scope of the invention will now occur to the reader.

What is claimed is:

1. A system for sharing electronic information, comprising:
a centrally managed electronic information management system;
means enabling a plurality of users to access the system;
at least one user metadata schema stored on the system associated with each of the plurality of users;
means for receiving, in accordance with the user metadata schema, user metadata pertinent to each of the plurality of users and storing the user metadata in association with each of the plurality of users;
a plurality of information assets electronically accessible on the system;
at least one asset metadata schema stored on the system associated with each of the plurality of information assets;
means for receiving, in accordance with the asset metadata schema, asset metadata pertinent to each of the plurality of information assets and storing the asset metadata associated with each of the plurality of information assets;
whereby the system persistently stores all user metadata and information asset metadata under centralized management.

2. The system of claim 1 wherein the plurality of information assets are selected from the group comprising a channel, mediacast, blog, calendar, page library, component library, and feed library.

3. The system of claim 2 wherein a separate metadata schema is associated with each of the plurality of information assets.

4. The system of claim and 1 and further comprising:
a plurality of workspaces accessible by users on the system, each of the workspaces comprising at least one page;
means for making an information asset accessible through a workspace; and
means for granting to a user permission to access a workspace.

5. The system of claim 4 and further comprising:
a page including multiple components;
at least one information asset on a page associated with a component of the page; and
means for identifying, within the metadata associated with the information asset associated with the component of the page, context information, the context information used to share the information asset with other components on a page.

6. The system of claim 4 wherein a page is selected from the group comprising a private page accessible to a single user, a common page accessible to users granted permission to access a workspace and a subscription page accessible to users granted permission to obtain a subscription.

7. The system of claim 1, and further comprising:
a plurality of items accessible on the system, each item comprising a function accessible by a user;
means for storing permissions for authorizing a user to access an item;
means for receiving from a user a request for access to an item; and
means for granting to the user access to the item in accordance with the stored permission.

8. The system of claim 7, wherein the plurality of items are selected from the group including a process, workspace, data, and information asset.

9. The system of claim 8, and further comprising:
means for enabling a user to search for a desired item; and
means for enabling a user to request a subscription to the desired item.

10. The system of claim 9, and further comprising:
means responsive to a user request for a subscription to an item for retrieving a stored permission to determine if the user has been granted access to the desired item;
means, if the user has not been granted access to the desired item, for communicating the request for a subscription to the desired item to the owner of the desired item.

11. The system of claim 10 and further comprising:
means for establishing an interest folder, the interest folder comprising a filter for filtering metadata associated with a subscribed item in accordance with filter parameters; and
means for, if the metadata associated with a subscribed item is in accordance with the filter parameters, making the subscribed item available in the interest filter.

12. The system of claim 11 and further comprising a second interest folder associated with the first interest folder, the second interest folder including a filter for filtering metadata associated with the items in the first interest folder whereby to make selected subscribed items from the first interest folder available in the second interest folder.

13. The system of claim 12 wherein the first and second interest folders are associated in a discrete tree configuration such that each item accessible within an interest folder stays within that interest folder.

14. The system of claim 12 wherein the first and second interest folders are associated in a roll-up tree configuration such that an item accessible within the first interest folder may be made available within the second interest folder.

15. The system of claim 12 and further including a third interest folder in association with the first and second interest folders; and wherein
each of the first, second and third interest folders having associated therewith both routing rules and filter information whereby an item within any of the first, second and third interest folders may be accessible through the other interest folders as determined by the routing rules and filter information.

16. The system of claim 12 and further comprising means for alerting a user when an item has been made accessible in an interest folder.

17. The system of claim 1 and further comprising:
means usable by an owner of an information asset for publishing the information along with the metadata associated with the information asset for access by other users in the system.

18. A method operable on a computer for sharing electronic information, comprising:
establishing on a computer a centrally managed electronic information management system;
enabling a plurality of users to access the system;
establishing at least one user metadata schema stored on the system associated with each of the plurality of users;
receiving, in accordance with the user metadata schema, user metadata pertinent to each of the plurality of users and storing the user metadata in association with each of the plurality of users;
establishing a plurality of information assets electronically accessible on the system;
establishing at least one asset metadata schema stored on the system associated with each of the plurality of information assets; and
receiving, in accordance with the asset metadata schema, asset metadata pertinent to each of the plurality of information assets and storing the asset metadata associated with each of the plurality of information assets;
whereby the system persistently stores all user metadata and information asset metadata under centralized management.

19. A system for sharing electronic information, comprising:
a centrally managed electronic information management system including a processor and a memory connected to the processor;
an interface enabling a plurality of users to access the system;
the system operative with software contained in the memory to perform the steps of:
storing at least one user metadata schema on the system associated with each of the plurality of users;
receiving, in accordance with the user metadata schema, user metadata pertinent to each of the plurality of users and storing the user metadata in association with each of the plurality of users;
providing a plurality of information assets electronically accessible on the system;
storing at least one asset metadata schema stored on the system associated with each of the plurality of information assets; and
receiving, in accordance with the asset metadata schema, asset metadata pertinent to each of the plurality of information assets and storing the asset metadata associated with each of the plurality of information assets;
whereby the system persistently stores all user metadata and information asset metadata under centralized management.
